(19) United States
(12) Patent Application Publication
(10) Pub. No.: US 2024/0027960 A1
(43) Pub. Date: Jan. 25, 2024

(54) HOLOGRAPHIC PRINTING SYSTEM AND HOLOGRAPHIC PRINTING METHOD USING SAME

(71) Applicant: Kyungpook National University Industry-Academic Cooperation Foundation, Daegu (KR)

(72) Inventors: Hak Rin KIM, Daegu (KR); Tae Hyun LEE, Daegu (KR)

(73) Assignee: Kyungpook National University Industry-Academic Cooperation Foundation, Daegu (KR)

(21) Appl. No.: 18/254,772

(22) PCT Filed: Nov. 23, 2021
(86) PCT No.: PCT/KR2021/017315

§ 371 Date: May 26, 2023

(30) Foreign Application Priority Data
Nov. 27, 2020 (KR) 10-2020-0162916

(51) Int. Cl. G03H 1/04

(52) U.S. Cl. CPC G03H 1/0476; G03H 2001/0439

(57) ABSTRACT

A holographic printing system according to an embodiment of the present disclosure is disclosed. The system may include: a light source; a geometrical phase holographic element having a phase retardation of λ/4; and an optical member for copying and printing a wavefront through self-interference of light transmitted through the geometrical phase holographic element. According to an embodiment, the light source, the geometrical phase holographic element, and the optical member may be disposed in a line. According to an embodiment, the geometrical phase holographic element and the optical member may be disposed with a predetermined distance therebetween, and the predetermined distance may be a distance that enables self-interference of light transmitted through the geometrical phase holographic element.

### TECHNICAL FIELD

The research has been performed under the support of “Electronics Technology Development Project” by Ministry of Industry, Trade, and Energy (20016297, Development of industrial AR device and operating system technology based on variable focus lens for safety of work at industrial site).

The present disclosure relates to a holographic printing system and a holographic printing method using the same. In more detail, the present disclosure relates to a holographic printing system using self-interference and a holographic printing method using the holographic printing system.

### BACKGROUND ART

A holographic printer technology is, in a broad meaning, classified into a wavefront printer and a stereo printer, depending on the way of implementation. Such technologies record 3D information of actual objects on a medium through holographic interference information and many companies has been continuously publishing the results of research for applying the technologies to the industry all over the world.

FIG. 1 is a schematic view showing an optical system of a holographic wavefront printing system of the related art.

Referring to FIG. 1, in order to configure an optical system for holographic wavefront printing of the related art, a light source having a short wavelength and high coherence is required by using a high-power laser light source. Further, a two-beam interference technique of dividing each path into two paths to split and combine a moving stage and a beam is used, whereby there is a defect that a delicate interference optical system that is vulnerable to vibration, etc. is required. Further, there is a problem that an optical system such as an expensive spatial light modulator (SLM) is required to copy/make many same holographic printings. Such holographic printing systems of the related art became a reason of reducing the diffraction efficiency of holographic printing materials, which can be made, and increasing the manufacturing cost.

### DETAILED DESCRIPTION OF THE INVENTION

### Technical Problem

An objective of the present disclosure is to provide a system that can perform holographic printing without using coherent light sources of the related art.

Another objective of the present disclosure is to provide a holographic printing system using a geometrical phase holographic element having a phase retardation value.

Objectives of the present disclosure are not limited to those described above and objectives not stated above will be clearly understood to those skilled in the art from the specification and the accompanying drawings.

### Technical Solution

A holographic printing system according to an embodiment of the present disclosure is disclosed. The system may include: a light source; a geometrical phase holographic element having a phase retardation of λ/4; and an optical member for copying and printing a wavefront through self-interference of light transmitted through the geometrical phase holographic element.

According to an embodiment, the light source, the geometrical phase holographic element, and the optical member may be disposed in a line.

According to an embodiment, the holographic printing system may be a holographic printing system based on a polarization self-interferometer.

According to an embodiment, the geometrical phase holographic element and the optical member may be disposed with a predetermined distance therebetween, and the predetermined distance may be a distance that enables self-interference of light transmitted through the geometrical phase holographic element.

According to an embodiment, the geometrical phase holographic element may perform holographic printing on the optical member by transmitting 50% of incident light from the light source as a polarized component the same as the incident light and transmitting the other 50% of the incident light from the light source as a polarized component modulated from the incident light to have self-polarization interference.

According to an embodiment, the optical member may be additionally coated with an optical anisotropic element and aligned in a patterned optical axis distribution to have a phase retardation of λ/2, whereby printing may be finished.

According to an embodiment, the light source may include an incoherent light source.

According to another embodiment, a method of performing holographic printing using the holographic printing system is disclosed.

According to an embodiment, the method may include: aligning the light source, the geometrical phase holographic element, and the optical member; sending light into the geometrical phase holographic element through the light source; performing holographic printing on the optical member through self-interference of light generated at the geometrical phase holographic element; and performing post-processing on the optical member.

According to an embodiment, the optical member may be disposed at a position at which a plurality of light beams generated at the geometrical phase holographic element forms an interference pattern by meeting again.

According to an embodiment, the performing of post-processing on the optical member may additionally coat an optical anisotropic element to have a phase retardation of λ/2.

### Advantageous Effects of the Invention

According to the present disclosure, there is an effect that it is possible to perform holographic printing using a small-sized optical system by using a self-interference technique and it is possible to remove optical noise that is generated in recording, as compared with existing optical systems in accordance with a reduced optical system difference.

Further, according to the present disclosure, there is an effect that since the path difference between two beams interfering with each other using a self-interference technique is very short, it is possible to perform holographic printing using an incoherent light source.

Effects of the present disclosure are not limited to those described above and effects not stated above will be clearly understood to those skilled in the art from the specification and the accompanying drawings.

### BRIEF DESCRIPTION OF DRAWINGS

FIG. 1 is a view illustrating a holographic printing system of the related art.

FIG. 2 is a view showing a holographic printing system according to an embodiment of the present disclosure.

FIG. 3 is a view illustrating holographic printing through the holographic printing system according to FIG. 1.

FIG. 4 is a diagram illustrating a method of creating a geometrical phase holographic element according to an embodiment of the present disclosure.

FIGS. 5 to 7 are views illustrating the characteristics of a geometrical phase holographic element according to an embodiment of the present disclosure.

FIG. 8 is a flowchart illustrating a holographic printing method according to an embodiment of the present disclosure.

### MODES FOR IMPLEMENTING THE INVENTION

Terminologies used herein and accompanying drawings are provided to easily describe the present disclosure and the present disclosure is not limited to the terminologies and drawings.

Well-known technologies that are in close connection with the spirit of the present disclosure of the technologies that are used in the present disclosure are not described in detail.

Hereafter, embodiments of the present disclosure will be described in detail with reference to the accompanying drawings so that those skilled in the art can easily accomplish the present disclosure. However, the present disclosure may be modified in various different ways and is not limited to the embodiments described herein. Further, in the following description of preferred embodiments of the present disclosure, when it is determined that detailed description of related well-known functions or configurations may make the spirit of the present disclosure unclear, they are not described in detail. Further, parts having similar functions and operations are given the same reference numerals throughout the drawings.

Unless described otherwise, “including” any components will be understood to imply the including of other components but not the exclusion of any other components. In detail, it will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Singular forms are intended to include plural forms unless the context clearly indicates otherwise. Further, the shapes and sizes of the components in the drawings may be exaggerated for more clear explanation.

Terms “˜unit” and “˜module” used throughout the specification, which are units that processes at least one function or operation, for example, may mean software or hardware components such as FPGA or ASIC. However, the term “˜unit” is not limited to software or hardware. A “˜unit” and a “˜module” may be configured to be stored in a storage medium that can be addressed or may be configured to regenerate one or more processors.

For example, a “˜unit” and a “module” may include components such as software components, object-oriented software components, class components, and task components, processors, functions, properties, procedures, subroutines, segments of a program code, drivers, firmware, a microcode, a circuit, data, a database, data structures, tables, arrays, and variables. Functions provided by components, and a “˜unit” and a “module” may be separately performed by a plurality of components, and “˜units” and “˜modules”, and may be integrated with other additional components.

FIG. 2 is a view showing a holographic printing system 1 according to an embodiment of the present disclosure.

According to a holographic printing system 1 according to an embodiment of the present disclosure, the holographic printing system 1 may include a light source 10, a geometrical phase holographic element 20, and an optical member 30. According to an embodiment, the light source 10, the geometrical phase holographic element 20, and the optical member 30 may be disposed and provided in a line.

The light source according to the present disclosure may be an incoherent light source. The light source 10 according to the present disclosure may be an LED light source. Unlike holographic printing systems of the related art where only light sources having a characteristic of a very large coherence length could be applied, there is an effect that the light source 10 of the holographic printing system 1 according to the present disclosure can be implemented using an incoherent light source without coherence such as an LED. Accordingly, there is an advantage in terms of reduction in volume and price of the holographic printing system 1. According to another embodiment of the present disclosure, a coherent light source may be used as the light source 10.

The geometrical phase holographic element 20 according to the present disclosure may be a geometrical holographic element having a phase retardation of λ/4 Quarter waveplate (WP). The geometrical phase holographic element 20 according to the present disclosure may be a geometrical holographic element having a phase retardation of 90 degrees.

A geometrical phase holographic element is a holographic optical element having characteristics of a very thin type and high diffraction efficiency using a photo-polymer, a silver-halide, a photo-resistor, etc. that are media for recording hologram interference patterns. A holographic element is recently actively used as the waveguide or the imaging optical element in virtual reality display such as AR, VR, and MR. A geometrical phase holographic optical element (GPH) of holographic elements means a holographic element showing different optical characteristics, depending on an incident polarization characteristic. As for the geometrical phase holographic element 20, it is possible to implement a flat characteristic and a polarization selective characteristic, depending on the cycle and the phase retardation degree of an optical anisotropic layer constituting the element, and it is also possible to reproduce a certain desired waveform.

The geometrical phase holographic element 20 according to the present disclosure is provided to have a phase retardation of λ/4 quarter waveplate (QWP), so it is possible to transmit a portion of the light source 10 traveling into the geometrical phase holographic element 20, modulate the other, and print a pattern formed through self-interference of the transmitted light and the modulated light from the geometrical phase holographic element 20 onto the optical member 30.

The holographic printing element according to the present disclosure can copy a certain wavefront on the optical member 30 on the basis of a geometrical holographic element (Geometrical Phase Hologram (GPH) that can copy a certain wavefront, on the basis of polarization interference.

Holographic printing may be performed on the optical member 30 through self-interference of light coming from the geometrical phase holographic element 20. The optical member 30 may be glass. However, the optical member 30 is not limited to this material and may be made of a material on which a wavefront can be recorded through self-interference of light. An optical alignment layer may be coated on a side of the optical member 30. An optical alignment layer may be coated on a side of the optical member 30 and an interference pattern formed by self-interference may be recorded on the optical alignment layer.

The holographic printing system according to the present disclosure may be a holographic printing system based on a polarization self-interferometer.

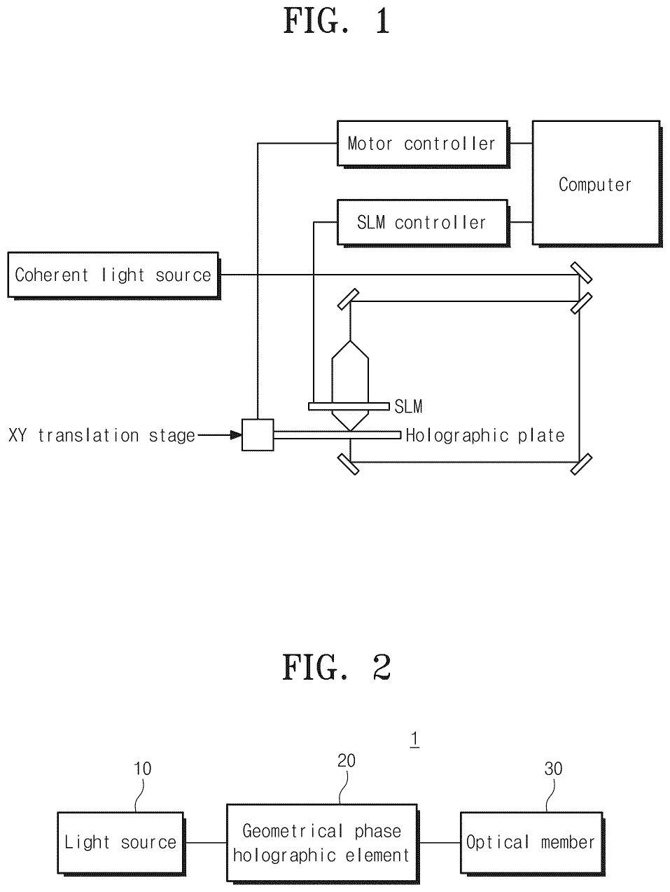

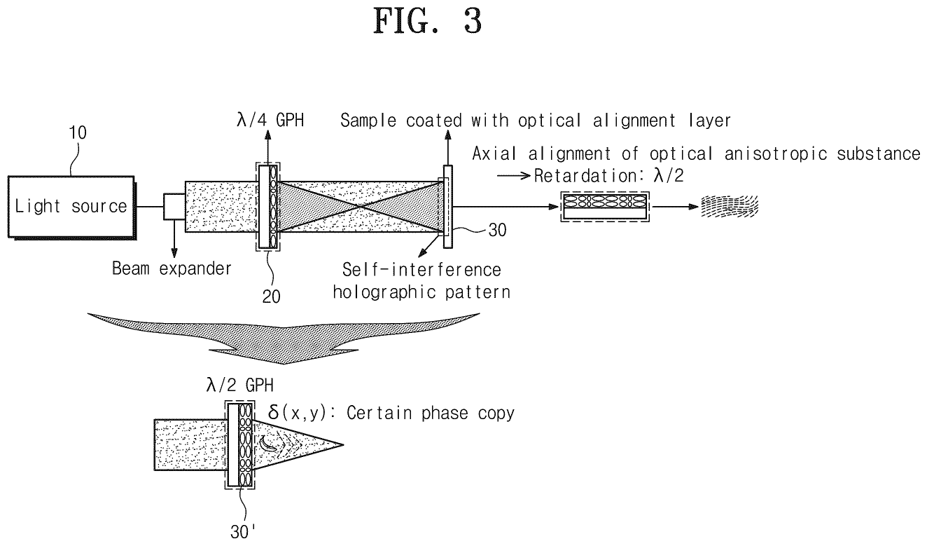

FIG. 3 is a view illustrating holographic printing through the holographic printing system 1 according to FIG. 1.

According to FIG. 3, a holographic printing system 1 in which a light source 10, a geometrical phase holographic element 20, and an optical member 30 are disposed in a line is disclosed. FIG. 3 shows a wavefront copy printing system using the geometrical phase holographic element 20 for wavefront copy.

According to FIG. 3, the geometrical phase holographic element 20 can transmit or modulate incident light from the light source 10. The geometrical phase holographic element according to the present disclosure is designed to have a phase retardation of λ/4, so it can transmit 50% of incident light from the light source 10 as a polarized component the same as the incident light and can transmit the other 50% of the incident light from the light source as a polarized component modulated from the incident light. According to an embodiment, the other 50% of the incident light from the light source 10 is transmitted as a polarized component modulated from the incident light, whereby it is possible to perform holographic printing on an optical member to have self-polarization interference. According to an embodiment, circular polarized light travels into the geometrical phase holographic element 20, 50% of the incident light is modulated as a wavefront the same as a wavefront recorded before, and the other 50% is transmitted with the same characteristic as the wavefront before incidence maintained. Further, the circular polarized state of a modulate wavefront is changed into an orthogonal circular polarization and a non-modulated wavefront maintains the incident circular polarized state. Two light waves provided wavefronts split, as described above, can form a polarization interference pattern through self-interference on the optical member 30 coated with an optical alignment layer. In this case, printing may be finished in the state aligned in patterned optical axis distribution. In this case, a beam traveling into the geometrical phase holographic element 20 has a self-interference system that is split and modulated itself and then forms an interference pattern, so it may have a very short light path between two beams of wavefront light.

That is, the geometrical phase holographic element 20 according to the present disclosure may form a polarization interference pattern for wavefront copy on the optical alignment layer formed on the optical member 30 using the incoherent light source 10 unlike holographic printers of the related art. Thereafter, it is possible to perform a process of coating and aligning an optical anisotropic element by a thickness for manufacturing a λ/2 QWP holographic element on the optical member 30 with the interference pattern formed thereon. Referring to FIG. 3, it shows a wavefront characteristic that is reproduced of a copied optical member 30′.

According to an embodiment, the geometrical phase holographic element 20 and the optical member 30 may be disposed with a predetermined distance therebetween. The predetermined distance may be a distance that enables self-interference of light transmitted through the geometrical phase holographic element 20.

That is, the holographic printing system 1 according to the present disclosure has an advantage that it is possible to perform holographic printing even without a complicated optical system and a high-price, high-power, and high-coherent laser light source 10 shown in FIG. 1 when performing holographic printing for reproducing the same wavefront using the geometrical phase holographic element 20 including wavefront information to be copied.

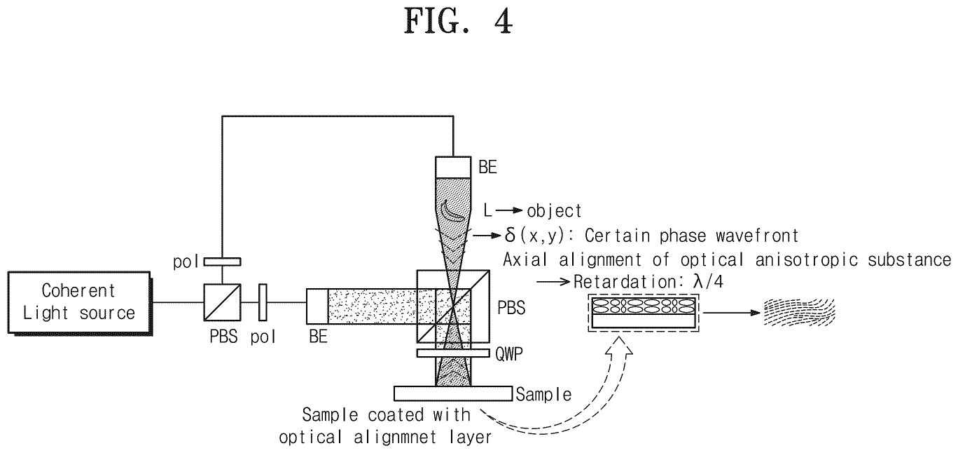

FIG. 4 is a diagram illustrating a method of creating a geometrical phase holographic element 20 according to an embodiment of the present disclosure.

According FIG. 4, an optical system that can create a geometrical phase holographic element 20 having a phase retardation of λ/4 to copy a certain wavefront is disclosed.

The optical system according to FIG. 4 may include a polarization beam splitter (PBS) for splitting and combining beams, an object for recording a wavefront, and a quarter waveplate (QWP) for polarization interference according to combination of a pair of orthogonal circular polarized light beams each having modulated phase. It is possible to record an interference pattern for an object on an element coated with an optical alignment layer through the optical system shown in FIG. 4, and a liquid crystal or photosensitive element is coated and aligned on the recorded element by a thickness that satisfies a condition of λ/4 QWP, whereby it is possible to manufacture the geometrical phase holographic element 20 for wavefront copy. In this case, the wavefront information of the object is stored in an optical axis distribution type of the λ/4 QWP manufacturing element. According to an embodiment, the wavefront characteristic to be copied may be induced (transmitted light or reflected dispersed light) even through the object in the embodiment of FIG. 4, but wavefront modulation may be performed in a digital holography type using an SLM.

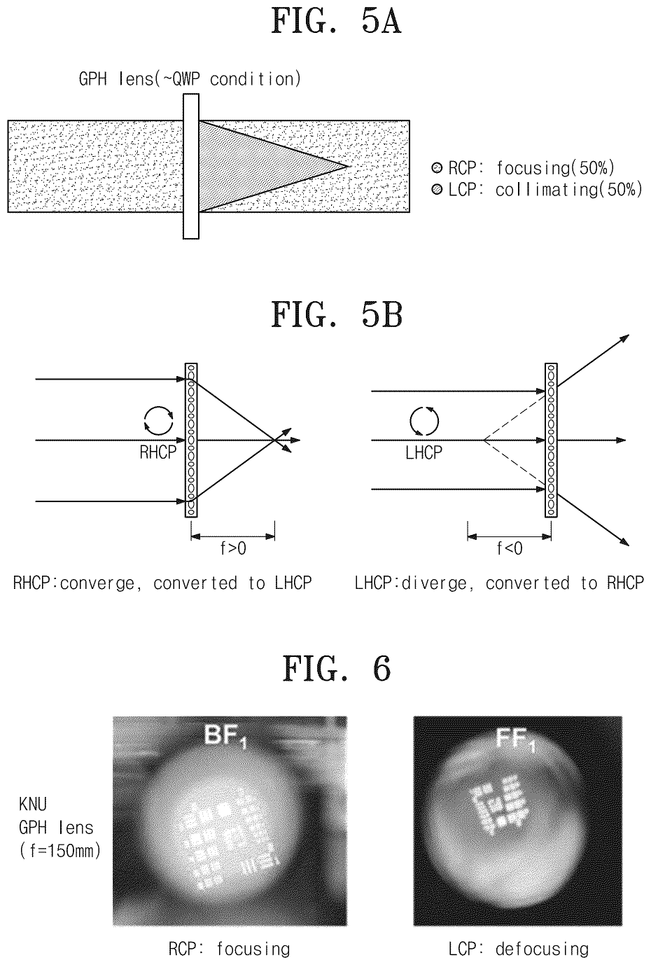

FIGS. 5 to 7 are views illustrating the characteristics of a geometrical phase holographic element according to an embodiment of the present disclosure.

FIGS. 5(a) to 5(b) are views illustrating the characteristics of transmitted light and modulated light when light is transmitted through the geometrical phase holographic element 20 according to the present disclosure.

The following Equation (1) is an equation showing optical characteristics when light having certain polarization travels into the geometrical phase holographic element 20. The light having certain polarization is split and phase-modulated into left circular polarized light and right circular polarized light and the diffracted by the geometrical phase holographic element 20, and a 0^{th}-order term in which incident polarization is maintained without be diffracted is determined in accordance with a phase retardation value of the geometrical phase holographic element 20.

$${e}^{i {δ}_{in}} \vert {χ}_{in} 〉 {\to }^{GPH} \sqrt{{η}_{+}} {e}^{i ( {δ}_{in} + 2 Φ )} \vert {χ}_{+} 〉 + \sqrt{{η}_{-}} {e}^{i ( {δ}_{in} - 2 Φ )} \vert {χ}_{-} 〉 + \sqrt{{η}_{0}} {e}^{i {δ}_{in}} \vert {χ}_{in} 〉 . \qquad ( 1 )$$

That is, A 0^{th}-order term and a diffracted term is defined as in the following Equations (2) and (3) in accordance with a phase retardation value of the geometrical phase holographic element 20. That is, according to the following Equations, if the phase retardation value of the geometrical phase holographic element 20 is λ/4, a 0^{th}-order term and a diffracted term may be split with 50% efficiency each.

$${η}_{o} = {cos}^{2} ( \frac{πΔ nd}{λ} ) \qquad ( 2 )$$

$${η}_{\pm 1} = \frac{1}{2} [ 1 ∓ {S}_{3}^{′} ] {sin}^{2} ( \frac{πΔ nd}{λ} ) \qquad ( 3 )$$

Accordingly, when left circular polarized (LCP) light travels into the geometrical phase holographic element 20, 50% of the incident light is diffracted while changing into right circular polarized (RCP) light, and the other 50% is transmitted with polarization maintained as left circular polarization. As described above, there is an effect that it is possible to equally copy a pattern of a QWP condition using two light beams split as left circular polarized light and right circular polarized light with intensity divided at 50:50.

FIG. 5(a) shows an embodiment of optical characteristics of a beam traveling in the geometrical phase holographic element 20 manufactured in accordance with the embodiment of FIG. 4. It can be seen that light traveling inside as left circular polarized light is modulated and split into modulated right circular polarized light (focusing beam) and left circular polarized light with a polarization component maintained (collimating beam). In this case, when recoding is performed with a recording medium at the intersection where two light beams meet again, there is an effect that the wavefront of the geometrical phase holographic element 20 at the previous state is recorded through self-interference.

FIG. 5(b) is a view illustrating that it is possible to implement the characteristics of both a convex lens and a concave lens by adjusting the polarization characteristic of light traveling into the geometrical phase holographic element 20.

The geometrical phase holographic element 20 can implement the characteristics of an existing bulky optical element having a very small thickness (<3 μm) and can implement very high optical efficiency theoretically reaching 100% under a selective polarization condition.

FIG. 6 shows an operation characteristic of an optical member 30 manufactured through the holographic printing system 1 proposed in the present disclosure, that is, a λ/2 geometrical phase holographic lens. It can be seen that when a beam of right circular polarization travels inside, an image operates as a convex lens, so an image with a focused object image is obtained, and when a beam of left circular polarization travels inside, a defocused image is obtained.

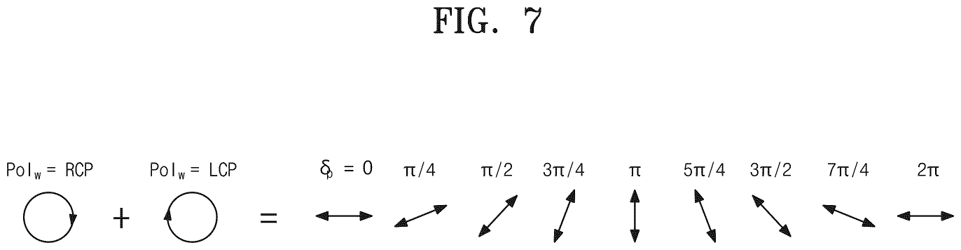

FIG. 7 is a conceptual view of a polarization interference map formed on a substrate in recording of a holographic printer proposed in the present disclosure. It can be seen that left circular polarized light and right circular polarized light are split and focused and defocused, respectively, circular polarized light is modulated in accordance with the phase difference of the two beams.

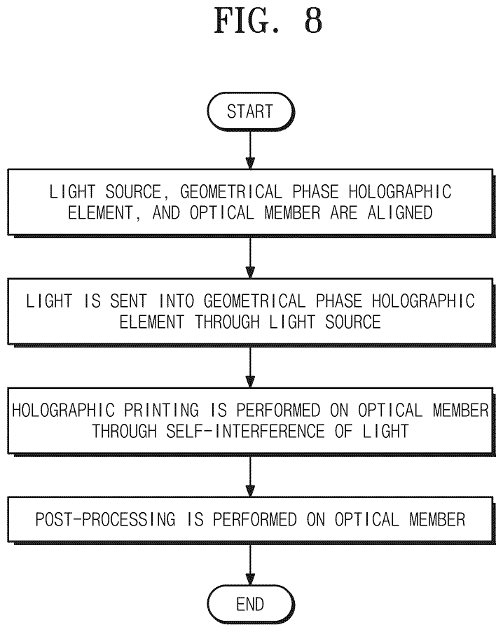

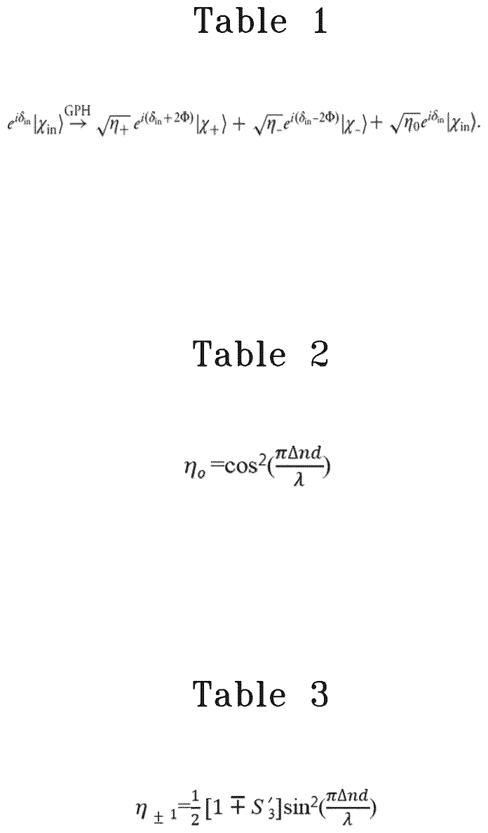

FIG. 8 is a flowchart illustrating a holographic printing method according to an embodiment of the present disclosure.

According to FIG. 8, a light source 10, a geometrical phase holographic element 20, and an optical member 30 are aligned, and light can be made travel into the geometrical phase holographic element 20 using the light source 10. In this case, the optical member 30 may be disposed at a position at which a plurality of light beams generated at the geometrical phase holographic element 20 forms an interference pattern by meeting again. Holographic printing is performed on the optical member 30 through self-interference of light generated at the geometrical phase holographic element 20 and then post-processing is performed on the optical member 30, whereby holographic printing can be performed. In this case, the step of performing post-processing on the optical member 30 may additionally coat an optical anisotropic element to have a phase retardation of λ/2.

According to the holographic printing method of the present disclosure, it can be seen that it is possible to copy a holographic element having efficiency of 100%, that is, a phase retardation of λ/2 through self-interference using the geometrical phase holographic element 20 having a phase retardation of λ/4 unlike optical systems of the related art. Since the holographic printing method according to the present disclosure uses a self-interference phenomenon in which an interference patterns is formed after one beam is split/modulated through a geometrical phase holographic element 20 rather than the related art in which two beams are directly split using a PBS and then combined through several optical systems, the path difference of interfered two beams is very short and there is no complicated optical system for splitting and then combining beams, so the holographic printing method has the advantage that it is possible to reduce even interference noise that is generated when copying a wavefront.

The holographic printing technology according to the present disclosure, which is a principle of copying a geometrical phase holographic element 20 on the basis of a self-interference phenomenon, can copy and print a geometrical phase holographic element 20 having diffraction efficiency of 100% and a phase delay value of λ/2 using a geometrical phase holographic element 20 having phase delay value of λ/4 for copying and printing a certain wavefront. The holographic printing technology according to the present disclosure has an effect that quick recording and manufacturing are possible without a moving stage through a self-interferometer using a geometrical phase holographic element 20 to copy a wavefront, as compared with existing wavefront copying printing systems (>1 day) that perform recording using a moving stage. Further, the holographic printing technology according to the present disclosure has an effect that it is possible to perform recording by a small-sized optical system by using a self-interference technique, as compared with existing delicate and bulky optical systems that are required for two-beam interference and it is possible to remove optical noise that is generated in recording, as compared with existing optical systems in accordance with a reduced optical system difference. Further, in a wavefront printing system using self-interference, the path difference between two interfering beams is very short, and accordingly, an incoherent light source 10 having little coherence can be used, which has an effect of having many advantages in terms of industry, as compared with a method that substantially uses a high-power coherence laser having long

1. A holographic printing system comprising:
a light source;
a geometrical phase holographic element having a phase retardation of 2\,/4; and
an optical member for copying and printing a wavefront through self-interference of light transmitted through the geometrical phase holographic element.

2. The holographic printing system of claim 1, wherein the holographic printing system is based on a polarization self-interferometer in which the light source, the geometrical phase holographic element, and the optical member are disposed in a line.

3. The holographic printing system of claim 2, wherein the geometrical phase holographic element and the optical member are disposed with a predetermined distance therebetween, and
the predetermined distance is a distance that enables self-interference of light transmitted through the geometrical phase holographic element.

4. The holographic printing system of wherein the geometrical phase holographic element performs holographic printing on the optical member by transmitting 50% of incident light from the light source as a polarized component the same as the incident light and transmitting the other 50% of the incident light from the light source as a polarized component modulated from the incident light to have self-polarization interference.

5. The holographic printing system of claim 4, wherein the optical member is additionally coated with an optical anisotropic element and aligned in a patterned optical axis distribution to have a phase retardation of 2\,/2, whereby printing is finished.

6. The holographic printing system of claim 5, wherein the light source includes an incoherent light source.

7. The holographic printing system of claim 1, wherein the geometrical phase holographic element forms at least two interference patterns by using one beam and splitting and/or modulating the one beam.

8. A method of performing holographic printing using the holographic printing system of claim 1, the method comprising:
aligning the light source, the geometrical phase holographic element, and the optical member;
sending light into the geometrical phase holographic element through the light source;
performing holographic printing on the optical member through self-interference of light generated at the geometrical phase holographic element; and
performing post-processing on the optical member.

9. The method of claim 8, wherein the optical member is disposed at a position at which a plurality of light beams generated at the geometrical phase holographic element forms an interference pattern by meeting again.

10. The method of claim 9, wherein the performing of post-processing on the optical member additionally coats an optical anisotropic element to have a phase retardation of 2\,/2.

11. The method of claim 8, wherein the geometrical phase holographic element forms at least two interference patterns by using one beam and splitting and/or modulating the one beam.
